(19) United States
(12) Patent Application Publication
(10) Pub. No.: US 2026/0261051 A1
(43) Pub. Date: Sep. 3, 2026

(54) Reflector Panel of a Parabolic Antenna

(71) Applicant: mtex antenna technology GmbH, Wiesbaden (DE)

(72) Inventors: Lutz Stenvers, Heidenrod-Martenrod (DE); Karl-Heinz Stenvers, Gronau (DE)

(21) Appl. No.: 19/145,212

(22) PCT Filed: Jan. 8, 2024
(86) PCT No.: PCT/EP2024/050274

§ 371 Date: Jul. 2, 2025

(30) Foreign Application Priority Data
Jan. 10, 2023 (DE) 10 2023 100 441.7
Jan. 10, 2023 (DE) 20 2023 100 179.3

(51) Int. Cl. H01Q 19/02; H01Q 15/16

(52) U.S. Cl. CPC H01Q 19/023; H01Q 15/165

(57) ABSTRACT

A reflector panel (1) of a parabolic antenna (4) has a front reflector surface (2) and a rear rib structure (3) connected thereto, wherein the reflector surface (2) is formed monolithically with that of the rib structure (3), and a reinforcement structure (12) is fixedly associated with the rib structure (3).

### CROSS REFERENCE TO RELATED APPLICATIONS

This application is the U.S. national stage of International Application No. PCT/EP2024/050274, filed on 2024 Jan. 8. The international application claims the priority of DE 102023100441.7 filed on 2023 Jan. 10 and the priority of DE 202023100179.3 filed on 2023 Jan. 10; all applications are incorporated by reference herein in their entirety.

### BACKGROUND

The invention relates to a reflector panel of a parabolic antenna, comprising a front reflector surface and a rear rib structure connected thereto, and to a parabolic antenna comprising at least one reflector panel.

A parabolic antenna within the scope of the invention comprises a main reflector having a diameter of approximately 5 to 100 m. For such large parabolic antennas, a plurality of reflector panels are associated with a support frame, wherein there should be as few gaps or other interruptions to the desired geometry of the main reflector between the individual reflector panels as possible.

Reflector panels of aluminum sheet construction have become established in practice. For manufacture, an aluminum sheet is stretch-drawn over a steel mold, whereby the parabolic shape of a reflector panel is formed by plastic deformation of the aluminum sheet. The deformed aluminum sheet is then adhered horizontally to the steel mold by using rigidifying aluminum ribs. This design allows the production of reflector panels for antennas which have a reception-and-transmission accuracy of up to approximately 30 GHz. Over the last 30 years, such parabolic antennas have been built in large numbers for satellite communications.

This manufacturing technology is mature for the mentioned field of application, but cannot be used for precise parabolic antennas in the higher frequency range. Adhering the reflector panel to the ribs creates a certain residual error in the surface accuracy after demolding. This is especially true for large reflector panels in a range of approximately 0.5 to 5 m. In addition, the accuracy of the reflector panel is directly dependent on the steel mold and is always lower than the accuracy of the steel mold. A steel mold having a surface accuracy of approximately 50 μm is customary, which results in a surface accuracy of the reflector panel of approximately 90 μm.

For special precision parabolic antennas having a reception-and-transmission range of approximately 500 to 1000 GHz, reflector panels made of carbon fiber composite materials (CFRP) have been used; however, depending on the accuracy of the parabolic antenna, reflector panels made of carbon fiber composite materials are very costly to manufacture, as high-precision molds made of steel, CFRP or a special glass and intensive manual labor are required in the manufacturing process using autoclave technology. Due to the complex manufacturing, these CFRP reflector panels are not suitable for the production in large numbers of precision parabolic antennas covered by the invention.

The decisive parameters for the performance of a parabolic antenna are the preservation of the shape of the reflecting paraboloid and the accuracy of its surface under all conceivable load cases to which the parabolic antenna is exposed during operation, wherein in particular dead weight loads at different reflector positions, wind loads, thermal loads such as temperature gradients in the structure and the like are taken into account. The shape fidelity is represented by the so-called ‘rms value’ (root mean square). This is the mean square error of the deviations, measured at many points, of the loaded real reflector surface of a parabolic antenna from the ideal or best-fit paraboloid. The permissible rms error must not exceed approximately 1/20 of the smallest wavelength of the electromagnetic radiation to be measured by using the relevant parabolic antenna. Errors larger than 1/15 of the smallest wavelength significantly reduce the quality of the parabolic antenna and no longer allow unrestricted use.

The following table contains the relevant parameters for different accuracy levels of a parabolic antenna; frequency, wavelength and surface accuracy:

TABLE 1

| | | Surface accuracy |
|---|---|---|
| Frequency (GHz) | Wavelength (mm) | (rms value in μm) |
| 20 | 15.0 | 750 |
| 40 | 7.5 | 375 |
| 60 | 5.0 | 250 |
| 100 | 3.0 | 150 |
| 200 | 1.5 | 75 |
| 300 | 1.0 | 50 |

In this regard, it is known from DE 10 2015 215 336 A1 that a parabolic antenna comprises a reflector panel which is milled in one piece, for example from aluminum, and which comprises a reflective, smooth surface on an upper side and transverse and longitudinal ribs which are formed on an underside. Furthermore, multiple reflector panels are associated with an additional reflector segment support, wherein each reflector panel is connected to the surface of the reflector segment support via multiple adjusting elements in order to align it in the desired direction. This does not provide any additional rigidification of the actual reflector panel.

Furthermore, DE 2 407 021 A discloses an antenna reflector comprising a segment for forming a parabolic antenna, wherein a waffle-type rib arrangement is cast on the rear sides of the segments. Further or additional reinforcement or rigidification of the segment is not addressed.

### SUMMARY

The invention is based on the object of creating a reflector panel and a parabolic antenna comprising a plurality of such reflector panels of the type mentioned above, which panel and antenna meet the requirements of precision parabolic antennas and can be produced in large numbers.

According to the invention, the object is achieved by the features of the independent claims.

### DETAILED DESCRIPTION

A reflector panel of a parabolic antenna comprises a front reflector surface and a rear rib structure connected thereto, wherein the reflector surface is formed monolithically with the rib structure and a reinforcement structure is fixedly associated with the rib structure.

A parabolic antenna comprises at least one previously described reflector panel associated with a support frame.

For such a precision parabolic antenna, the reflector surface and the rib structure are manufactured by machining from an aluminum blank, which in particular has a length of between 0.5 and 3.5 m, preferably between 1.5 and 3 m, particularly preferably between 2 and 2.5 m, preferably 2.3 m, and a width of between 0.5 and 3.5 m, preferably between 1.5 and 3 m, particularly preferably between 2 and 2.5 m, preferably 2.1 m, and a height of between 0.02 and 0.5 m, preferably between 0.04 and 0.1 m and preferably of approximately 0.07 m. The height or thickness of the aluminum block to be machined depends substantially on the geometry of the reflector surface to be manufactured and the maximum height of the ribs of the rib structure.

During the production of the reflector panel, the rear rib structure is first manufactured by machining. The height of the ribs depends in particular on the geometry of the rib structure, i.e. in particular on the length of the ribs between two nodes, as well as on the height of the rib, wherein, as is well known, the height of the rib makes a substantial contribution to its flexural rigidity, but has a problematic effect during machining, in particular by milling, due to vibrations, which is why the rib height is limited. However, since the greatest possible rigidity of the reflector panel is essential to achieve the lowest possible rms value of the parabolic antenna, a reinforcement structure is fixedly associated with the rib structure. The reflector surface is then manufactured by machining, in particular by milling. Thus, the rib structure and the associated reinforcement structure provide a relatively high resistance to deformation of the reflector surface.

A parabolic antenna comprising a plurality of reflector panels according to the invention, which are associated with a support frame for alignment, meets the requirements for a precision parabolic antenna having a reception-and-transmission range of approximately 10 to 1000 GHZ, preferably 20 to 500 GHZ, preferably 30 to 300 GHz.

Machining the reflector panel and fitting the reinforcement structure enables the production of relatively large numbers of reflector panels having the same or different curvature of the reflector surface comprising an associated reinforcement structure by using a justifiable machining effort.

The dependent claims show advantageous embodiments of the invention.

Expediently, the reinforcement structure comprises reinforcing bars extending between coupling elements. The reinforcing bars reduce deflection of the reflector panel. The coupling elements can be column-like elements to which the reinforcing bars, the longitudinal sides of which are associated with the ribbed structure, are fixed by their end faces. The coupling elements are fixedly connected to the rib structure, in particular at nodes where multiple ribs meet. The coupling elements can be cylindrical or polygonal in cross-section, or tubular, for example, to reduce weight. The reinforcement structure can in particular also be manufactured from a metal alloy, in particular from a light metal.

In order to erect at least a kind of outer frame using the reinforcement structure, the coupling elements are fixed in embodiment at least at peripheral corner points of the ribbed structure.

A quasi star-shaped reinforcement structure can be achieved by fixing a coupling element in the center of the rib structure according to a further embodiment. The reinforcing bars therefore also extend from the corner points of the outer frame into the center of the rib structure or the reflector panel.

To reduce the lengths of the reinforcing bars, at least one coupling element is arranged between two peripheral corner points of the rib structure according to a further development.

Preferably, the coupling elements are screwed and/or adhered and/or crimped to the rib structure. For this purpose, corresponding threaded bores or fitting bores are recessed into the aluminum at the nodes of the rib structure where there is a material accumulation, and the outer diameters of the coupling elements that are to be inserted into the threaded bores or fitting bores have a corresponding design.

The coupling elements preferably comprise longitudinal slots for receiving associated reinforcing bars in a directed manner. For example, the coupling elements arranged at corner points are provided with three longitudinal slots in order to be able to hold two reinforcing bars forming the peripheral edge and one reinforcing bar pointing in the direction of the center in a correspondingly aligned manner. The coupling element fixed in the center of the rib structure can comprise four to eight longitudinal slots for holding a corresponding number of reinforcing bars arranged in a cross or star shape.

To increase the stability of the reinforcing bars manufactured from strip, flat bar or sheet material, the reinforcing bars comprise an angled portion on at least one free longitudinal side. To further stabilize the reinforcing bars, beading can be embossed into the radius formed on the angled portion.

Preferably, the reinforcing bars extend at least circumferentially to the rib structure, wherein associated longitudinal sides of the reinforcing bars are supported on free rib longitudinal sides. Thus, the rib structure and the associated reinforcement structure provide a relatively high resistance to deformation of the reflector surface. The reinforcing bars are adhered to the parallel ribs of the rib structure. Furthermore, the reinforcing bars can also be adhered to the coupling elements.

It is understood that the features mentioned above and still to be explained below can be used not only in the respectively specified combination, but also in other combinations. The scope of the invention is defined only by the claims.

### BRIEF DESCRIPTION OF THE DRAWINGS

The invention is explained in more detail below on the basis of embodiments and with reference to the associated drawings.

In the drawings:

FIG. 1 is a perspective view of a reflector panel according to the invention,

FIG. 2 is a perspective view of the reflector panel according to FIG. 1 comprising an unmachined reflector surface,

FIG. 3 is a partial perspective view of the rear of the reflector panel according to FIG. 2,

FIG. 4 is a further enlarged partial view of the reflector panel according to FIG. 3,

FIG. 5 is a third enlarged view of the reflector panel according to FIG. 2,

FIG. 6 is an enlarged view of detail VI according to FIG. 4,

FIG. 7 is an enlarged view of detail VII according to FIG. 5,

FIG. 8 is a schematic view of a parabolic antenna comprising reflector panels and

FIG. 9 is another schematic view of a parabolic antenna comprising reflector panels.

### DETAILED DESCRIPTION OF THE PREFERRED EMBODIMENTS

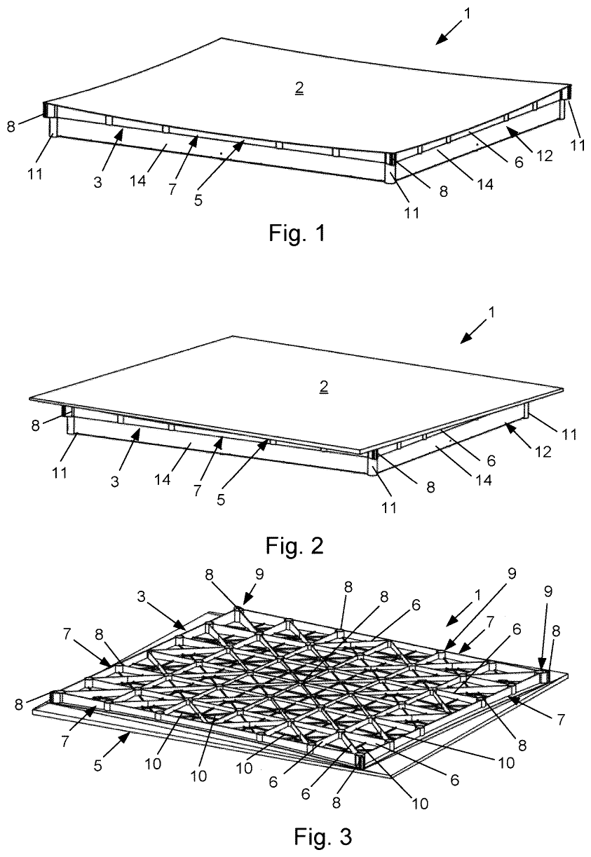

The reflector panel 1 according to FIG. 1, which comprises a square base, comprises, in contrast to the reflector panel 1 according to FIG. 2, a machined reflector surface 2 having a curvature as intended. Due to the machining, the height of the edge 5 of the machined reflector surface 2 according to FIG. 1 is only a fraction of the height of the edge 5 of the unmachined reflector surface 2. For example, the machined reflector surface 2 is approximately 1 to 3 mm, preferably approximately 2 mm thick, and the unmachined reflector surface 2 is approximately 13 to 22 mm, preferably between 15 and 18 mm thick, wherein the raw and finished dimensions depend in particular on the curvature to be milled and on the stability required for the subsequent operations.

On the side of the reflector panel 1 that faces away from the reflector surface 2, a rib structure 3 comprising a plurality of individual ribs 6 can be seen according to FIG. 3. The rib structure 3 is manufactured by machining, in particular by milling, a cuboid-shaped aluminum blank, so that the reflector surface 2, which is also to be machined in a further manufacturing step, in particular by milling, and the rib structure 3 are monolithic, i.e. formed in one piece. Here, the rib structure 3 forms an edge structure 7 with respect to the circumferential edge 5 of the reflector surface 2, wherein the ribs 6 are interrupted by nodes 8 in a grid-like manner. The nodes 8 show accumulations of material into which bores 9 are recessed. The bores 9 can, for example, be provided with internal threads. Ribs 6 extend diagonally in the rib structure 3 between two opposite nodes 8 of the edge structure 7, wherein the diagonally aligned ribs 6 are also interrupted in their course by nodes 8, so that nodes 8 arranged and aligned in a grid-like manner are comprised within the rib structure 3. In a quadrilateral spanned by four nodes 8, comprising circumferential ribs 6 and at least one rib 6 which runs diagonally, further ribs 10, which may have a lower height, are aligned and arranged such that these further ribs 10 bisect the length of the circumferential ribs 6 and the at least one rib 6 which runs diagonally.

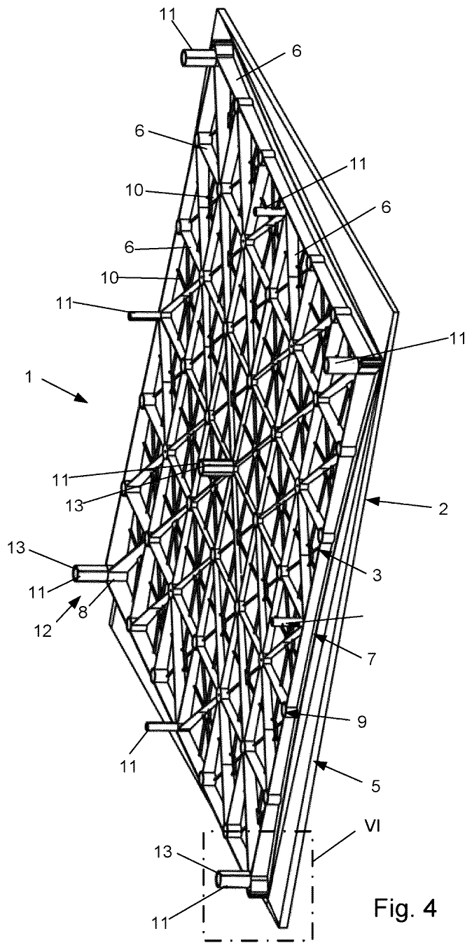

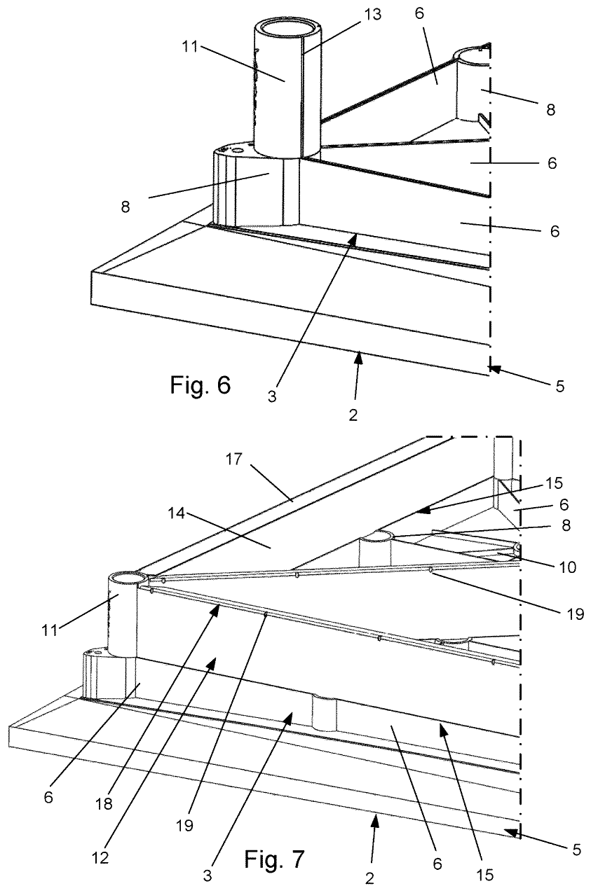

According to FIG. 4 and FIG. 6, coupling elements 11 of a reinforcement structure 12 are inserted, preferably screwed, pressed or adhered, into the bores 9 of the nodes 8 at the corners of the edge structure 7 as well as in its side-bisecting nodes 8 and the central node 8, so that in any case a firm connection of the coupling elements 11 to the rib structure 3 is established. The coupling elements 11 comprise longitudinal slots 13 extending along the longitudinal side, the number and orientation of which slots corresponds to the reinforcing bars 14 of the reinforcement structure 12 to be received.

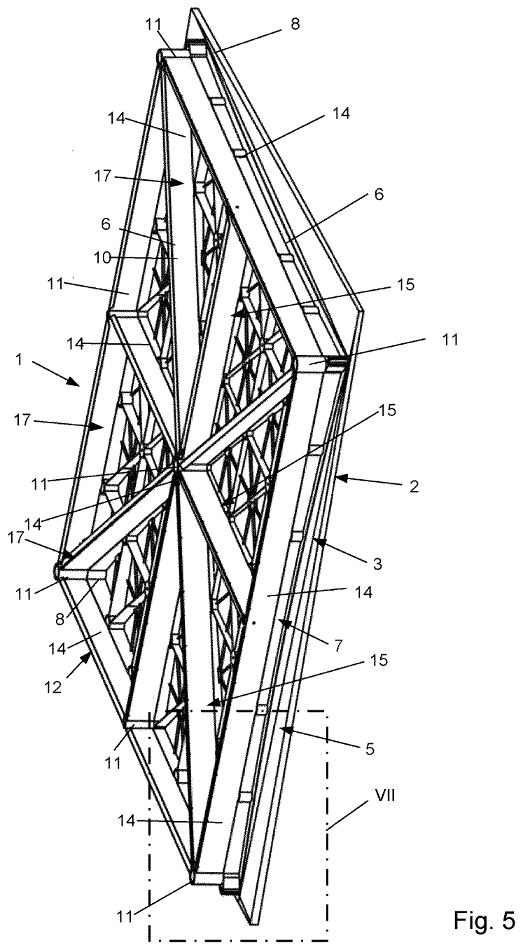

According to FIG. 5 and FIG. 7, the reinforcing bars 14 of the reinforcement structure 12 are arranged and aligned parallel to the ribs 6 of the edge structure 7 and in a star shape in the direction of the central coupling element 11 and are inserted by their end faces into the longitudinal slots 13 of the associated coupling elements 11. The longitudinal sides 15 of the reinforcing bars 14 of the reinforcement structure 12 are supported on the associated ribs 6 or the rib longitudinal sides thereof and are adhered thereto in order to establish a firm connection.

The reinforcing bars 14 of at least one free longitudinal side 15, which is opposite the longitudinal side 15 associated with the ribs 6, comprise an angled portion 17, into the radius 18 of which beading 19 are pressed for further stabilization.

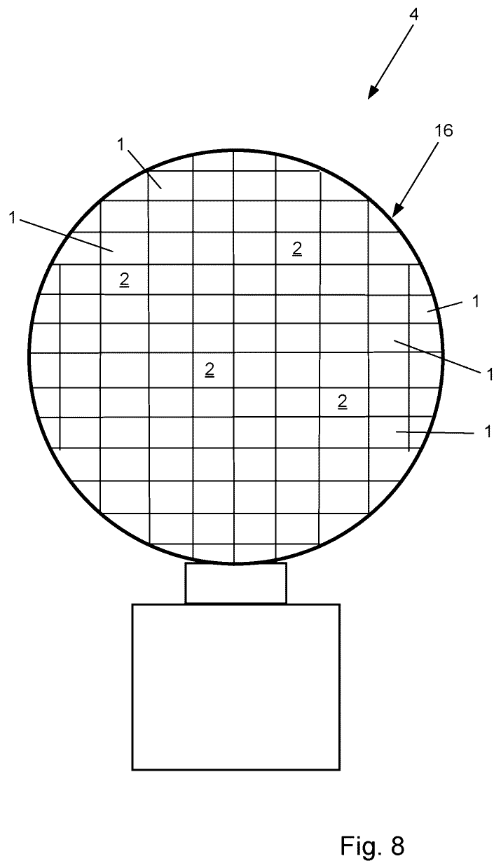

A main reflector 16 of the parabolic antenna 4 according to FIG. 8 has, for example, a diameter of between 5 and 100 m, preferably between 10 and 80 m, preferably between 15 and 70 m. A main reflector 16, in particular of a parabolic antenna in the field of radio astronomy, comprises a plurality of reflector panels 1. The multiple main reflectors 16 of an array of up to several hundred parabolic antennas 4 are aligned such that during signal evaluation, the reception performance and in particular the selectivity are substantially increased and thus in particular a substantially enlarged area of a so-called virtual single parabolic antenna 4 can be achieved.

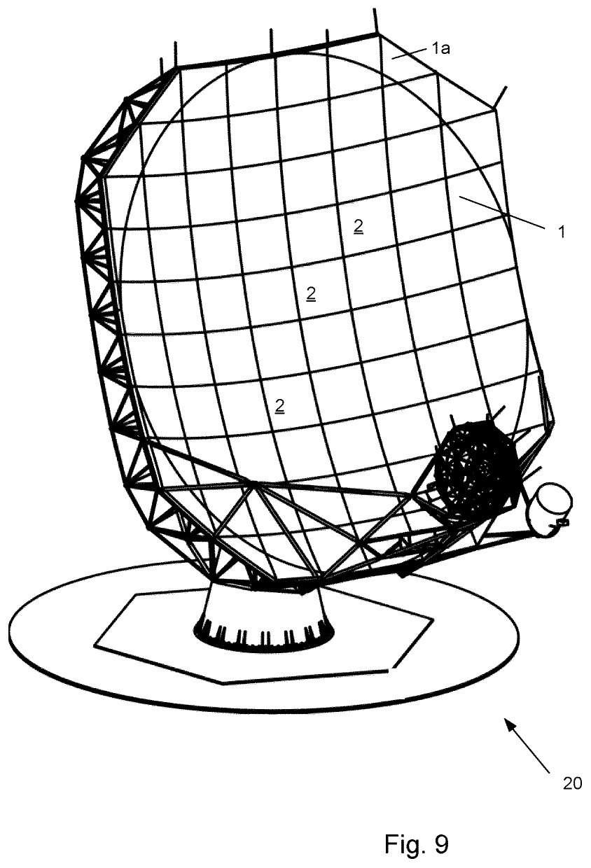

Finally, FIG. 9 shows an offset antenna 20 comprising a shaped surface which defines undisturbed optics and has no shadows. In this offset antenna 20, the metal reflector panels 1, preferably manufactured from aluminum, are rectangular and each have approximately the same dimensions. However, each individual reflector panel 1 has a slightly different curvature; they are not parabolic reflector panels 1 in contrast to the panels from the prior art. The unique feature of these reflector panels 1 is the size of 2.5 m by 2.1 m, giving an area of 5.25 m² per reflector panel 1, and a precision that enables the reception of electromagnetic radiation at a frequency of up to 360 GHz. The offset antenna 20 comprises a main reflector of 21 m by 18 m and supports 68 rectangular reflector panels 1 and eight triangular reflector panels 1a. The shape of the reflector surface 2 was determined, for example, by means of ‘aperture vector optimization’. In contrast to the above-mentioned prior art, the reflector panels 1 and their respective are not formed parabolically. This offset antenna 20 is therefore the currently highest-performing radio telescope in the frequency range mentioned.

The special design of the individual reflector panel plays a substantial role in this.

Starting with a heat-treated aluminum block of 2.6 m by 2.2 m by 0.07 m (length, width, height), a fine rib structure 3 is milled on one side of the block, which rib structure gives a remaining sheet thickness of 2 mm the necessary stability in conjunction with the created rib structure 3 at the end of the manufacturing process. But this step is only carried out at the very end of the manufacturing process because the remaining rigidity is needed for manufacture until then. This means that the substantial part of the panel rigidity can now be added. The milled aluminum part, which is only 70 mm thick, is now ribbed by using 1.5 mm thin and 130 mm high aluminum sheets as a reinforcement structure 12. These reinforcing bars 14 are held by a total of nine aluminum cylinders, which are used as coupling elements 11 and are fixedly screwed to the milled part. The reinforcing bars 14 are adhered directly to the pre-milled fine rib structure 3. Finally, aluminum covers are riveted and screwed onto the coupling elements 11 of a reflector panel 1, so that the high reinforcing bars 14 are rigidly and load-bearingly connected to the milled part and the height of the reflector panel 1 is increased from 70 mm to 200 mm. The reflector panel 1 composed of the reflector surface 2 comprising the rib structure 3 formed in one piece and the additional reinforcement structure 12 is no longer formed in one piece. Having this increased rigidity, the final reflector surface 2 of the reflector panel 1 can now be milled and, as measurements have shown, a large reflector panel 1 having a surface accuracy of 16 μm rms value is obtained.

In order to demonstrate the influence of the surface accuracy of the reflector panels 1 on the performance of the parabolic antenna 4, a computational comparison is made between a parabolic antenna 4 equipped with the reflector panels 1, hereinafter referred to as panel A, the reflector surface 2 of which is formed monolithically with that of the rib structure 3, wherein a previously explained reinforcement structure 12 is fixedly associated with the rib structure 3, and a parabolic antenna 4 equipped with a reflector panel 1 known from the prior art, hereinafter referred to as panel.

Panel A has a surface area of 4.87 m², four corner adjusters and one center adjuster for alignment.

Panel B is produced from standard aluminum sheet construction and is dimensioned so as to achieve the best possible performance with respect to the height of the ribs 6, sheet thickness and number of rigidifying ribs 6. Panel B has a surface area of 4.33 m², four corner adjusters and one center adjuster for alignment.

In detail, the load-dependent surface errors are distributed using the example of a parabolic antenna 4 for 100 GHz transmission/reception power with a main reflector 16 with a diameter of approximately 20 m as follows (values in μm rms value):

| Panel | A | B |
|---|---|---|
| Manufacture | 20 | 90 |
| Max. dead weight | 9 | 17 |
| Wind 7 m/s | 6 | 10 |
| Change in ambient temperature by 25° C. | 3 | 11 |
| Solar radiation 1360 W/m2 | 22 | 74 |
| Adjustment | 30 | 30 |
| Total error RSS* | 44 | 122 |
| Main reflector support structure | | |
| Max. dead weight | 80 | 80 |
| Wind 7 m/s | 16 | 16 |
| Change in ambient temperature by 25° C. | 45 | 45 |
| Max. temperature gradient 5° C. in x, y, z direction | 44 | 44 |
| Total error RSS* | 103 | 103 |
| Total error RSS* | | |
| Panel and main reflector support structure | 112 | 160 |
| Requirement for 100 GHz according to Table 1 | 150 | 150 |
| Margin | +38 | −10 |

(RSS* is the squared total error of an antenna)

### CONCLUSION

Panel A has an exceptionally low surface error of 44 μm RSS. Panel B, having a value of 122 μm RSS, is worse than panel A by a factor of 2.8. This difference is driven by the high but typical manufacturing error of 90 μm rms value for panel B. By using the same main reflector support structure and a total error of 103 μm RSS, a margin for the parabolic antenna 4 comprising panel A of +38 μm rms value is obtained, whereas the parabolic antenna 4 comprising panel B is capped at −10 μm rms value and therefore does not meet the specification for a 100 GHz antenna according to Table 1.

LIST OF REFERENCE NUMERALS

| | |
|---|---|
| 1. | Reflector panel |
| 2. | Reflector surface |
| 3. | Rib structure |
| 4. | Parabolic antenna |
| 5. | Edge of 2 |
| 6. | Rib |
| 7. | Edge structure |
| 8. | Node |
| 9. | Bore |
| 10. | Rib |
| 11. | Coupling element |
| 12. | Reinforcement structure |
| 13. | Longitudinal slot |
| 14. | Reinforcing bar |
| 15. | Longitudinal side of |
| 16. | Main reflector |
| 17. | Angled portion |
| 18. | Radius |
| 19. | Beading |
| 20. | Offset antenna |

1. Reflector panel (1) of a parabolic antenna (4), comprising a front reflector surface (2) and a rear rib structure (3) connected thereto, wherein the reflector surface (2) is formed monolithically with that of the rib structure (3), and a reinforcement structure (12) is fixedly associated with the rib structure (3).

2. Reflector panel (1) according to claim 1, characterized in that the reinforcement structure (12) comprises reinforcing bars (14) which extend between coupling elements (11).

3. Reflector panel (1) according to claim 1, characterized in that the coupling elements (11) are fixed at least at peripheral corner points of the rib structure (3).

4. Reflector panel (1) according to claim 1, characterized in that a coupling element (11) is fixed in the center of the rib structure (3).

5. Reflector panel (1) according to claim 1, characterized in that at least one coupling element (11) is arranged between two peripheral corner points of the rib structure (3).

6. Reflector panel (1) according to claim 1, characterized in that the coupling elements (11) are screwed and/or adhered and/or crimped to the rib structure (3).

7. Reflector panel (1) according to claim 1, characterized in that the coupling elements (11) comprise longitudinal slots (13) for receiving associated reinforcing bars (14) in a directed manner.

8. Reflector panel (1) according to claim 1, characterized in that the reinforcing bars (14) comprise an angled portion (17) on at least one free longitudinal side (15).

9. Reflector panel (1) according to claim 1, characterized in that the reinforcing bars (14) extend at least circumferentially to the rib structure (3), with associated longitudinal sides (15) of the reinforcing bars (14) being supported on free rib longitudinal sides.

10. Reflector panel (1) according to claim 1, characterized in that the reinforcing bars (14) extend in a star shape from the corner-side coupling elements (11) to the central coupling element (11), with associated longitudinal sides (15) of the reinforcing bars (14) being supported on free rib longitudinal sides.

11. Reflector panel (1) according to claim 1, characterized in that that the reinforcing bars (14) are adhered to associated ribs (6) of the rib structure (3).

12. Reflector panel (1) according to claim 1, characterized in that the rib structure (14) comprises ribs (6, 10) of different heights, with ribs (10) with which no reinforcing bars (14) are associated having, at least in part, a lower height than ribs (6) with which reinforcing bars (14) are associated.

13. Reflector panel (1) according to claim 1, characterized in that the reflector surface (2) comprises a concave geometry.

14. Reflector panel (1) according to claim 1, characterized in that the reflector surface (2) and the rib structure (3) are manufactured by milling from a monolithic aluminum block.

15. Parabolic antenna (4) comprising at least one reflector panel (1) according to claim 1, which is associated with a support frame.
